(19) United States
(12) Patent Application Publication
(10) Pub. No.: US 2002/0080273 A1
(43) Pub. Date: Jun. 27, 2002

(54) Appliance with TV and INTERNET modes of operation

(76) Inventors: Robert G. Harrison, Seattle, WA (US); Robert D. Lamson, Seattle, WA (US)

Correspondence Address: MILLER NASH LLP, 4400 TWO UNION SQUARE, 601 UNION STREET, SEATTLE, WA, 98101-2352, US

(21) Appl. No.: 09/730,519

(22) Filed: Dec. 5, 2000

Related U.S. Application Data
(60) Provisional application No. 60/115,197, filed on Jan. 6, 1999.
(60) Provisional application No. 09/516,247, filed on Mar. 1, 2000.
(60) Provisional application No. 60/174,964, filed on Jan. 6, 2000.
(60) Provisional application No. 60/115,005, filed on Jan. 6, 1999.

(51) Int. Cl. H04N 7/173

(52) U.S. Cl. 348/552

(57) ABSTRACT

Multimode appliances with modules which have only TV and INTERNET modes of operation. The module can be controlled with a remote control or a wireless keyboard, both capable of generating signals in the electromagnetic portion of the spectrum. The module may be of the stand alone type, or it may be designed for mounting to an overhead structure such as a kitchen cabinet.

### CROSS-REFERENCE TO RELATED APPLICATIONS

This application is related to and copending with U.S. patent application Ser. No. 09/479,274 filed Jan. 5, 2000. The benefit of the filing date of the of the '274 application is claimed.

The '274 application is entitled to the benefit of the filing date of provisional application No. 60/115,197 filed Jan. 6, 1999. The benefit of the filing date of the '197 provisional application is also claimed.

This application is also related to copending U.S. patent application Ser. No. 09/516,247 filed Mar. 1, 2000. The '247 application was copending with provisional application No. 60/174,964 filed Jan. 6, 2000, and that application was copending with provisional application No. 60/115,005 filed Jan. 6, 1999. The benefit of the filing dates of the '247, '964, and '005 applications is also claimed.

### TECHNICAL FIELD OF THE INVENTION

The present invention relates to novel, improved appliances which have a TV mode of operation and an INTERNET mode of operation.

### BACKGROUND OF THE INVENTION

Heretofore invented have been certain new and novel appliances with multiple, user-selectable operating modes. The appliances are capable of carrying out different ones of multiple functions. A function is called up by choosing the appropriate, user-selectable mode. Examples of the operating modes which different ones of the subject appliances have and the function of the appliance in each of these modes appear below.

| Mode | Function |
|---|---|
| TELEVISION | Allows the user to watch television. |
| CD | Allows the user to play a conventional audio (or |
| | audio/visual) disk; in this mode the user can also play a |
| | disk of the character described in U.S. Pat. |
| | Nos. 5,724,102 and 5,801,784 to retrieve lessons on a |
| | particular subject or information on performing a |
| | task from the disk. |
| APPLIANCE | Gives the integrated module control over one or more |
| | appliances - as examples only, a kitchen range, |
| | refrigerator, central heating system, air conditioner, or |
| | central vacuuming system. Also, diagnostic information |
| | on the controlled appliance(s) may be gathered and made |
| | available on the display screen of the appliance and at a |
| | service or repair facility or a user's cell phone. |
| SECURITY | Allows one to visually identify and converse with a |
| | person at an entry way, and to unlock a door at the |
| | entry way, all from the location of the appliance; |
| | the appliance can also be used in this mode to monitor |
| | an area remote from the appliance -- a baby's bedroom, |
| | for example. |
| INTERNET | Allows a user to log onto and browse the Internet and to |
| | send e-mail messages. |

### SUMMARY OF THE INVENTION

It has been found that there is a demand for appliances of the character disclosed in the above-cited '274 and '247 applications which have but two modes of operation—TV and INTERNET. It is suggested in the '274 application that such appliances might be produced by disenabling unwanted modes of an appliance with those, and other, operating modes.

Now invented, and disclosed herein, are appliances in which the same result—the provision of TV and INTERNET modes only—is achieved in a simpler, novel manner. This is advantageous from the viewpoint of manufacturing and service costs and for other reasons that will become apparent to the reader.

Like their counterparts disclosed in the '274 and '247 applications, the appliances embodying the principles of the present invention are intended to be controlled by a keyboard or a remote control or both of these types of devices. These devices can also advantageously be made simpler than their previously disclosed counterparts because only two mode selection buttons or keys are needed.

Another advantage of the novel appliances disclosed herein is that they may be produced in a countertop version or a version in which the appliance is mounted to an overhead structure such as an array of kitchen cabinets.

Yet another significant advantage of the appliances disclosed herein is that they retain all of the important attributes and features of the appliances disclosed in the '274 and '247 applications.

The objects, advantages, and features of the present invention will be apparent to the reader from the foregoing and the appended claims and as the ensuing detailed discussion and description of the invention proceeds in conjunction with the accompanying drawings.

### BRIEF DESCRIPTION OF THE DRAWINGS

FIG. 1 is a generally pictorial view of: (a) a wireless appliance which has user-selectable TV and INTERNET modes of operation; (b) embodies the principles of the present invention; and (c) includes an integrated unit (or module) and two input devices—a remote control and a keyboard—for controlling the operation of the integrated unit, also in accord with the principles of the present invention;

FIG. 2 is a plan view of the FIG. 1 keyboard;

FIG. 3 is a plan view of the FIG. 1 remote control;

FIG. 4 shows, in block diagram form, the operating components of the FIG. 1 appliance;

FIGS. 5-8 are flow diagrams showing mode selection options that a user of the FIG. 1 appliance may exercise;

FIG. 9 is a flow diagram showing in more detail the operation of the FIG. 1 appliance operated when the option shown in FIG. 8 is exercised by a user;

FIG. 10 is a front view of a second appliance embodying the principles of the present invention; in this case the appliance is mounted to overhead cabinets;

FIG. 11 is a perspective view of the FIG. 10 appliance;

FIG. 12 is a side view of the FIG. 10 appliance showing how a display unit of the FIG. 10 appliance can be quickly folded up and out of the way against the integrated unit of the appliance; and

FIG. 13 shows how the display unit is first rotated and then folded up against the integrated unit so that the screen of the display unit is protected by the casing of that unit.

### DETAILED DESCRIPTION OF THE INVENTION

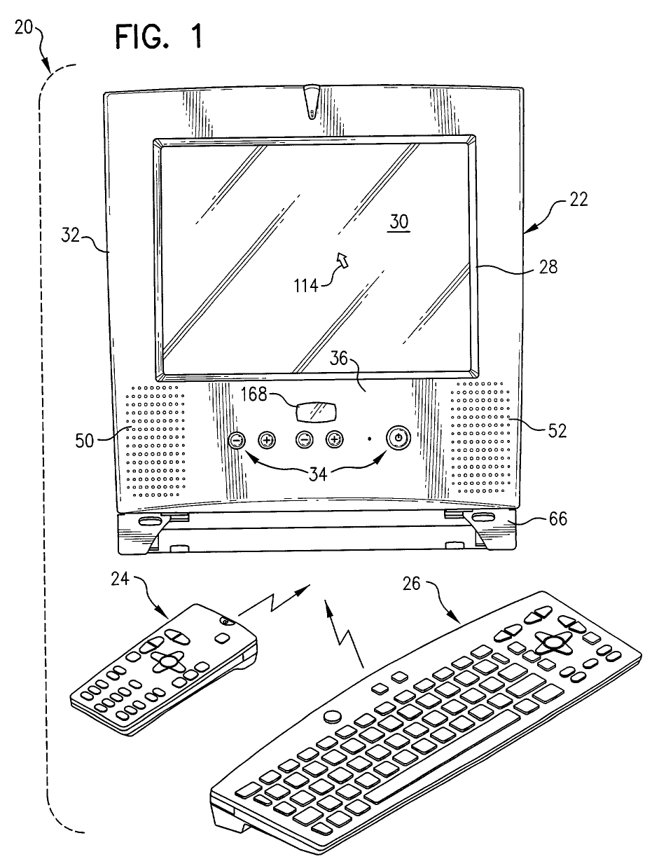

One currently representative and important application of the present invention is the provision of appliances which are designed for use in a kitchen. A system or appliance suitable for this (and other) applications of the invention is illustrated in FIG. 1 and identified by reference character 20.

The major components of system 20 are: an integrated unit (or module) 22, a remote control 24, and a waterproof keyboard 26. This keyboard is employed by a system user with system 20 in its INTERNET mode of operation in sending e-mail messages, to reach web sites which cannot be accessed by clicking on a link from a home page of controlled context, and to carry out other functions as described in copending application Ser. No. 08/707,623 filed Dec. 17, 1999. Remote control 24 can be similarly used except for composing e-mail messages, a limitation imposed by the lack of character keys.

Integrated unit 22 includes a television unit 28 which has a CRT (cathode ray tube) screen 30 (or a LED or other display) housed in a cabinet 32. Conventional onboard controls 34 for television 28 are located on the front panel 36 of cabinet 32.

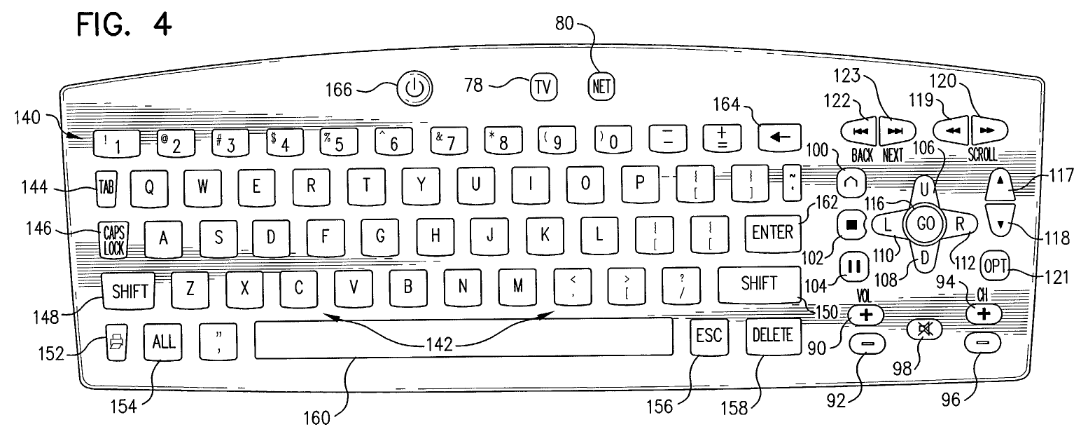

The operating components of integrated unit 22 and ancillary items activated in different operating modes of system 20 are depicted schematically in FIG. 4 and collectively identified by reference character 38.

These components include: a video switch/display driver unit 40 and an audio switch/speaker driver unit 42. Video signals appearing on I/O line 44 (which may be coupled to a VCR or DVD player, for example) or on cable/antenna line 46 are processed by a television controller/digital tuner unit 48 and routed to video and audio units 40 and 42 when appliance 20 is operated in the TV mode to provide a visual display on screen 30 and to produce audible sound by speakers 50 and 52.

In the INTERNET mode of operation of appliance 20, incoming signals appearing on one of the Ethernet, USB, and phone line connections 54, 56, or 58 are processed by an Internet controller 60 with the controller generated signals being routed to video and audio switch/driver units 40 and 42.

The display/driver units 40 and 42, television controller/digital tuner 48, and Internet controller 60 are located on a main controller board 62 and are powered by a D.C. power supply fed by a 120V a.c. line 64. The main controller board is mounted on the chassis 66 of appliance 20.

Ethernet connection 54 allows appliance 20 to be networked with other, compatible devices such as additional appliances of the character disclosed herein, a scanner, or a printer, to name but a few. The Ethernet connection also lets appliance 20 be connected to the Internet via a DSL or other broad bandwidth link.

USB connection or port 56 is provided so that ancillary devices which support this type of connection can be connected to appliance 20. Such devices include, but are not limited to, printers, scanners, external modems and hard drives, data back-ups, etc. Phone line 58 is used for dial-up connections to the Internet.

Preferred remote controls and keyboards such as those identified by reference characters 24 and 26 communicate with integrated unit 22 of appliance 20 by signals in the infrared portion of the magnetic spectrum.

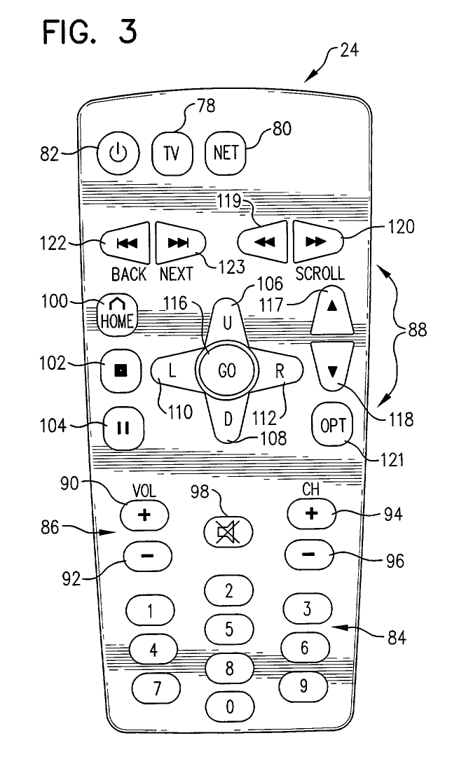

Referring now to FIG. 3, the TELEVISION and INTERNET modes of operation are selected by the user of appliance 20 with push button mode controls 78 (TV) and 80 (NET) of remote control 24, and the integrated unit 22 of the appliance is turned on and off with ON-OFF push button control 82.

Remote control 24 also has a numerical keypad 84 with push buttons \mathring{1} through \mathring{0} and two groups of push buttons respectively identified by reference characters 86 and 88. The push buttons of group 86 are employed in the TELEVISION (TV) mode of operation. They function in the same manner as conventional television controls:

The controls in group 86 are: volume UP and DOWN buttons 90 and 92, channel UP and DOWN buttons 94 and 96, and mute button 98. Channels can also be selected with keypad buttons \mathring{1}-\mathring{0}.

Considering then the buttons in group 88, HOME button 100 is used in the INTERNET mode of operation of appliance 20 to return an appliance user to a home page. STOP and PAUSE buttons 102 and 104 are also used in the INTERNET mode of operation, typically when streaming video or streaming audio or other downloading of a file is involved. The STOP button 102 returns the system user to the beginning of the file. The PAUSE button 104 stops the downloading operation at the point where the downloading operation is when the button is pushed. Pushing button 104 a second time causes the downloading to continue from the point where it was interrupted.

UP, DOWN, LEFT, and RIGHT buttons 106, 108, 110, and 112 are used with appliance 20 in its INTERNET mode of operation to move a cursor 114 (see FIG. 1) around screen 30 of module 22. GO button 116 is pressed to “click on” and select an option pointed to by cursor 114.

Also available with appliance 20 in its INTERNET mode of operation are SCROLL UP, SCROLL DOWN, SCROLL LEFT, and SCROLL RIGHT buttons 117, 118, 119, and 120. The SCROLL buttons are used to shift a displayed website page up, down, left, or right to bring into view a part of a page which is too large to fit on screen 30.

Pressing OPTIONS button 121 brings a menu of choices up on screen 30. With appliance 20 in the INTERNET mode the choice might be:

Dial Hang-up (connects appliance 20 to and disconnects the appliance from the Internet)

Refresh

Go To

Set-up

Done (Exit from the menu)

A representative menu of choices with appliance 20 operating in the TV mode is:

Video Set-up (brightness, contrast, color, etc.)

Audio Set-up (bass, treble, stereo or mono)

Auto Channel Program

Channel Add

Video Input (antenna, cable)

Done

Choices are made by using buttons 106 . . . 112 to move cursor 114 to the desired choice and then clicking on GO button 116.

Also found in control group 88 are BACK and NEXT buttons 122 and 123. These buttons are used only in the Internet mode of operation of appliance 20. One surfing the Internet can use BACK button 122 to step back through linked pages that have been brought up on screen 30. NEXT button 123 is used to step forward through pages that have previously been brought up.

Additional details of remote control 24 are found in U.S. Pat. No. 5,748,254 which is hereby incorporated by reference.

Referring now to FIG. 4, keyboard 26 is of the character described above and disclosed in the above-cited, '247 application.

The keyboard has the above-discussed keys of remote control 24 except for numerical keypad 84. Instead keyboard 26 has the customary row 141 of numbers \mathring{1} through \mathring{0}. The same reference characters have been used to identify the common controls in FIG. 3 (remote control) and FIG. 4 (keyboard).

Keyboard 26 also has both character and function keys akin to those found on a conventional keyboard. The character keys—collectively identified by reference character 142-may be those constituting a conventional QWERTY key set. The function keys include Tab, Caps Lock, Left-hand Shift, Right-hand Shift, Control, Alt, Escape, Delete, Space, Enter (Return), and Backspace keys 144 . . . 164 as well as On/Off key 166.

Additional details of keyboard 26 appear in copending application Ser. No. 09/466,103 which is hereby incorporated in this application by reference.

Infrared signals peculiar to the activated push buttons (remote control 24) or keys (keyboard 26) are transmitted to an IR receiver 168 on main controller board 62. Receiver 168 transmits appropriate digital commands to Internet controller 60 and television controller/digital tuner 48.

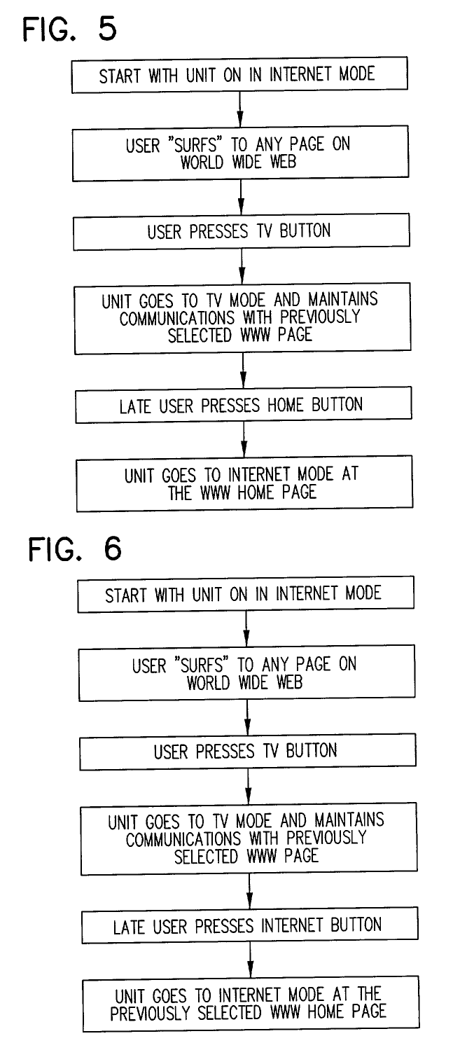

FIGS. 5-9 disclose different operating schemata for appliance 20. With the appliance on and in the INTERNET mode, a user may surf to any page on the worldwide web. The user may then elect to watch TV. To do so, he/she presses TV mode button 78 on remote control 24 or keyboard 26. This results in appliance 20 going into the TV mode.

Later, the user may decide to return to the web. In the FIG. 5 scenario, the appliance user wises to go to his/her homepage. This is done simply and directly by pressing HOME button 100. This causes appliance 20 to go back into the INTERNET mode and call up the home page.

One of the significant features of the present invention is that a user can, with appliance 20 in the INTERNET mode, switch to the TV mode and then back to the INTERNET mode such that the web page that was up when the user switched out of the INTERNET mode will be returned to. How this is accomplished is shown in FIG. 6.

Again, the scenario is that appliance 20 is turned on and in the INTERNET mode, allowing the user to surf to any page on the web as in the FIG. 5 scenario. Also, as in that scenario, the user can elect to watch TV by pressing TV button 78. Appliance 20 thereupon goes into the TV mode, maintaining connections with the web page that was up when the user left the INTERNET mode. To reenter the INTERNET mode at the same page, the user presses INTERNET button 80 instead of HOME button 100. This causes appliance 20 to go back into the INTERNET mode at the same web page that was up when the user switched out of the INTERNET mode.

FIG. 7 deals with the scenario which starts with appliance 20 turned off and the user wishing to operate the appliance in the INTERNET mode. This may be accomplished directly by pressing INTERNET button or key 80. The unit will stay in the INTERNET mode until the appliance is turned off or the TV mode is selected.

In the scenario depicted in FIG. 8, appliance 20 is turned off, and the user presses ON-OFF button 82. This causes the appliance to come on in the default, TV mode. The appliance remains in that mode until the user turns off the appliance or selects the INTERNET mode.

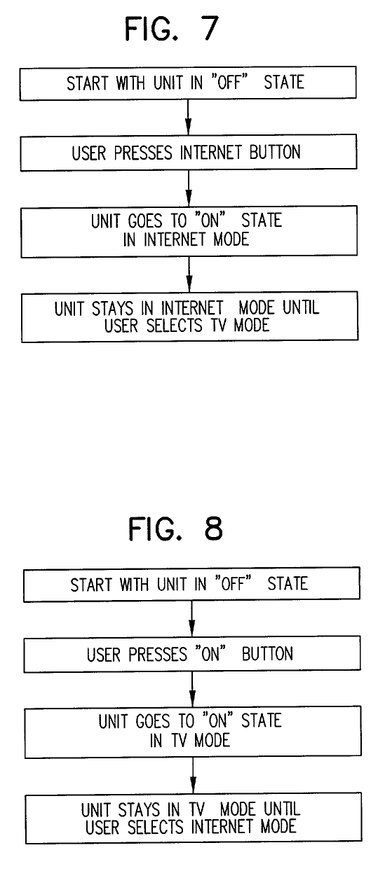

What happens when appliance 20 is turned on and the mode buttons 78 and 80 pressed is shown in more detail in FIG. 9. When the appliance is powered up, it comes on in the default, TV mode as just discussed; and the channel to which the TV unit 28 is set appears on screen 30. If INTERNET mode button 80 is not pressed, the appliance remains in the TV mode.

If, instead, INTERNET mode button 80 is pressed, appliance 20 switches to the INTERNET mode; and, if a dial-up Internet service provider is being used, starts dialing the provider's telephone number. A status message appears at this point on screen 30. This will typically successively indicate that the provider's number is being dialed, that the user's account is active, that the user's password has been accepted, and that appliance 20 is connected to the Internet. This last message will continue to be displayed until the user disconnects from the Internet by turning appliance 20 off or pressing TV mode button 78. In the latter instance, screen 30 will continue to display the Internet disconnected message while appliance 20 will switch to the TV mode of operation, and the channel to which TV unit 28 is tuned will be reached.

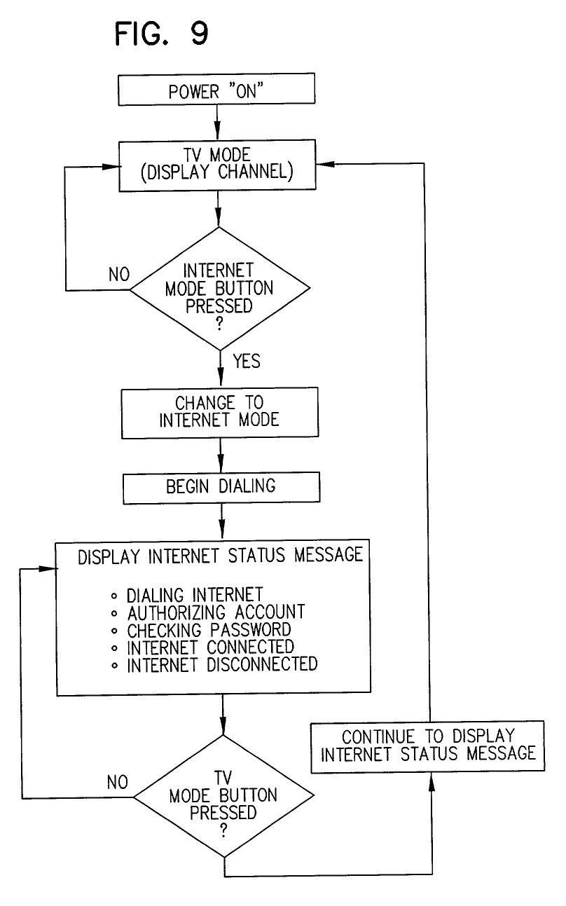

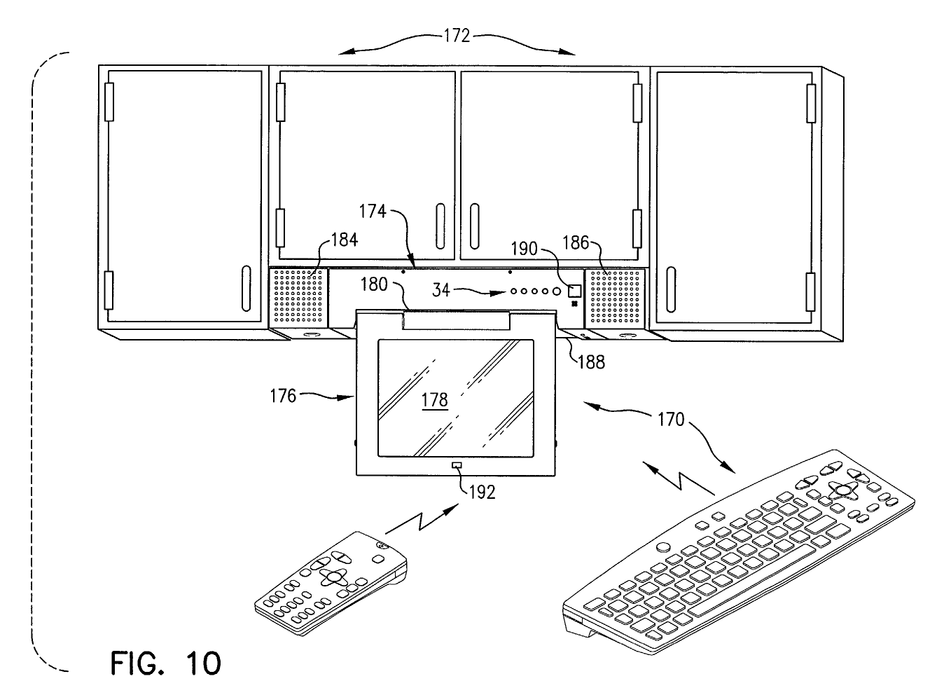

The appliance 20 shown in FIG. 1 and discussed above has a free-standing integrated unit or module 22 and is intended to be supported on a kitchen counter or other horizontal surface. FIGS. 10-13 illustrate a second TV/INTERNET appliance 170 which is instead designed to be mounted to overhead cabinets such as those collectively identified by reference character 172 in FIG. 10.

TV 28 displays the channel last selected when TV mode button 78 or ON-OFF button 82 of remote control 24 or ON-OFF button 166 of keyboard 26 is pressed.

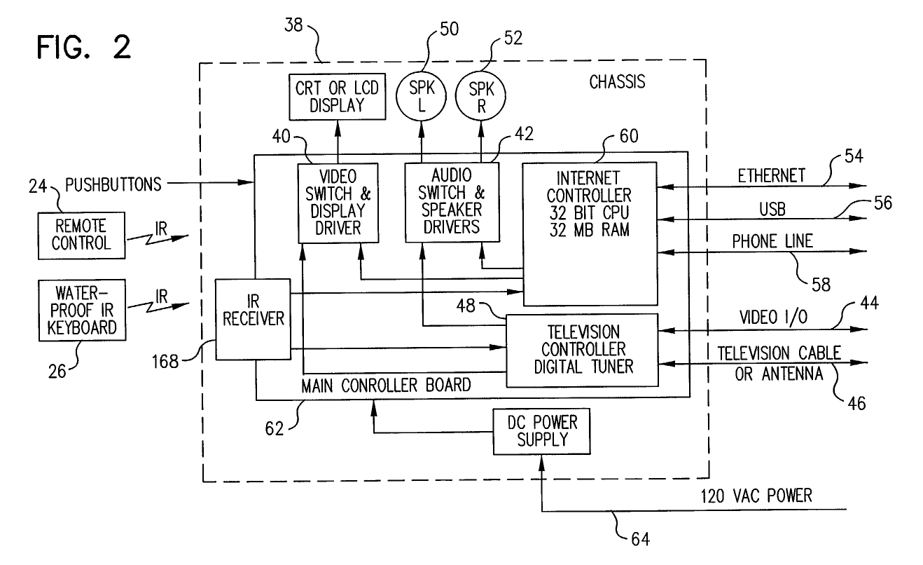

Appliance 170 includes an integrated unit (or module) 174 and a display unit 176 with a flat screen 178. The display unit is supported from module 174 by a universal type coupling 180. Commands and data can be inputted to module 174 by remote control 24 or keyboard 26. Audio speaker units 184 and 186 are located at opposite ends of module cabinet 168. The operating components of appliance 170 may duplicate those illustrated in FIG. 2 and described above except that appliance 170 has IR receivers on both the integrated unit 174 of the appliance (reference character 190) and the display unit (reference character 192).

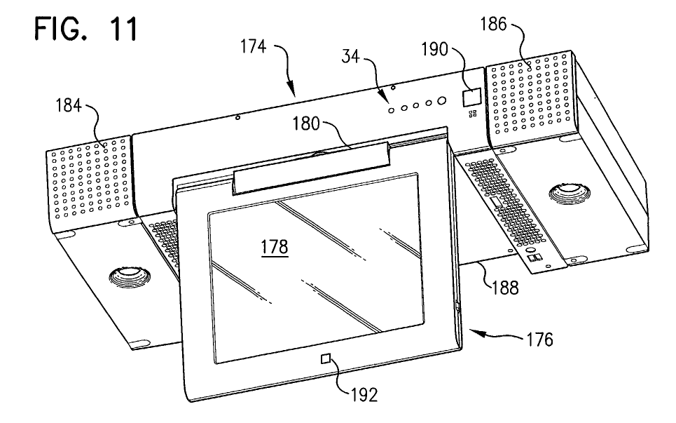

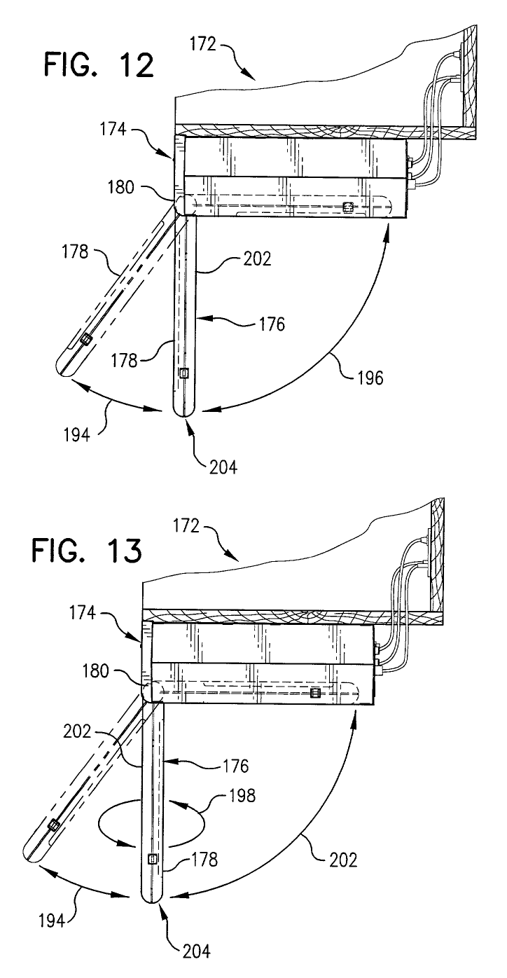

It was pointed out above that a universal-type coupling mechanism, identified by reference character 180, is used to connect the display unit 176 of appliance 170 to integrated unit 174. This allows the display unit to be tilted and rotated to face a viewer (arrow 194, FIGS. 12 and 13). Furthermore, pivot mechanism 180 allows display unit 176 to be folded up against the module with the screen 178 of the display unit exposed (arrow 196, FIG. 12) (which is the easiest and fastest) or with the display unit first rotated (arrow 198, FIG. 13) and then folded upwardly (arrow 200, FIG. 13) so that the back panel 202 of the display unit housing 196 covers the screen 178 of the display unit, protecting the screen from damage.

Universal pivot mechanism 180 includes a clutch (not shown) which retains the display unit screen 178 in the orientation to which it is adjusted by a user or other viewer. This is important because a flat screen, which screen 178 is, must be viewed head-on or nearly head- on for the displayed image to be satisfactorily seen.

For additional details on the universal mechanism 180 and other components of appliance 170, the reader is referred to copending application Ser. No. 09/516,427 which is hereby incorporated by reference.

The invention may be embodied in many forms without departing from the spirit or essential characteristics of the invention. For example, while the input devices described above operate at IR frequencies, this is not a requisite; and devices operating in the radio or other parts of the electromagnetic spectrum can instead be employed. The present embodiments are therefore to be considered in all respects as illustrative and not restrictive. The scope of the invention is indicated by the appended claims rather than by the foregoing description. All changes which come within the meaning and range of equivalency of the claims are intended to be embraced therein.

What is claimed is:

1. An appliance which only has an INTERNET mode of operation and a TV mode of operation:
said appliance having the capability of connecting the appliance to the Internet and concomitantly displaying a worldwide web home page;
said appliance also having the capability of bringing up and displaying pages which are directly or indirectly linked to said home page; and
said appliance further having the capability, when the appliance is switched out of its INTERNET mode and then back into said mode, of returning to a web page displayed when the appliance was switched out of the INTERNET mode.

2. An appliance as defined in claim 1 which also has the capability, selectable by a user of the appliance, of returning to the worldwide web home page when the appliance is switched from the TV mode to the INTERNET mode.

3. An appliance as defined in claim 1 which, if switched out of the TV mode and then back to the TV mode, will return to the channel which was active when the appliance was switched out of the TV mode.

4. An appliance which comprises:
an integrated unit with only TV and INTERNET operating modes; and an input device for transmitting data to said integrated unit by signals in a selected part of the electromagnetic spectrum.

5. An appliance as defined in claim 4 in which the input device has the capability of generating and transmitting signals in the infrared portion of the electromagnetic spectrum.

6. An appliance as defined in claim 4 in which the input device is a remote control.

7. An appliance as defined in claim 4 in which the input device is a keyboard.

8. An appliance as defined in claim 4 in which the input device has exactly two mode selection controls, said controls being a TV control and an INTERNET control.

9. An appliance as defined in claim 4 which has an input device with the following controls:
BACK and NEXT controls for moving backwards and forwards through Internet web pages;
a set of LEFT, RIGHT, UP and DOWN scroll controls for moving a page relative to a screen component of the appliance;
a second, separate set of LEFT, RIGHT, UP and DOWN buttons for moving a cursor about the screen component of the appliance; and
a GO control used to bring up a web page indicated by the cursor.

10. An appliance as defined in claim 9 in which the input device has an OPTIONS control operable to bring up on the screen component a menu of choices available to a user of the appliance, said OPTIONS control being usable in both the TV and INTERNET modes of operation of the appliance.

11. An appliance as defined in claim 9 which has a STOP control operable with the appliance in its INTERNET mode of operation to terminate the downloading of an Internet file.

12. An appliance as defined in claim 9 which has a PAUSE control operable with the appliance in its INTERNET mode of operation to first stop the downloading of a web file and to then cause the downloading of the file to continue from the point where it was stopped.

13. An appliance as defined in claim 9 in which the input device has a numerical keypad.

14. An appliance as defined in claim 9 in which the input device has a keyboard with keys corresponding to the letters of the alphabet.

15. An appliance as defined in claim 4 in which said integrated unit is of the stand alone type and is constructed to sit on a horizontal surface.

16. An appliance as defined in claim 4 in which the integrated unit has the capability of being mounted to an overhead structure.

17. An apparatus as defined in claim 4 wherein the capabilities of the integrated unit are provided by operating components which include:
a video switch/display driver;
an audio switch/speaker driver;
an INTERNET controller operatively connected to the video switch/display driver and the audio switch/speaker driver; and
a television controller/digital tuner also operatively connected to the video switch/display driver and the audio switch/speaker driver.

18. An appliance as defined in claim 17 in which the television controller/digital tuner has a connection for a television cable or antenna and the Internet controller has Ethernet, USB, and phone line connections.

19. An appliance which can be turned on and off and has an INTERNET mode of operation and an INTERNET mode control for selecting that mode of operation; said appliance having the capability of coming on in the INTERNET mode if, when the application is off, a user activates the INTERNET mode control.

20. An appliance as defined in claim 19 which has a TV mode of operation and an ON-OFF control and wherein, if a user activates the ON-OFF control when the appliance is off, the appliance will come on in the TV mode.

21. An appliance as defined in claim 20 which has a TV mode control and wherein, if a user activates the TV control when the appliance is off, the appliance will come on in its TV mode of operation.

22. An appliance as defined in claim 19 which has the capability, when the appliance is switched out of its INTERNET mode and then back into said mode, of returning to a web page displayed when the appliance was switched out of the INTERNET mode.

23. An appliance as defined in claim 19 which has a TV mode of operation and the capability, selectable by a user of the appliance, of returning to a worldwide web home page when the appliance is switched from the TV mode to the INTERNET mode.

24. An appliance as defined in claim 19 which, if switched out of the TV mode and then back to the TV mode, will return to the channel which was active when the appliance was switched out of the TV mode.
